(19) United States
(12) Patent Application Publication
(10) Pub. No.: US 2008/0265029 A1
(43) Pub. Date: Oct. 30, 2008

(54) Method and apparatus for verifying contents of containers marked with machine-readable identifiers

(76) Inventor: B. Sean Graves, Charlottesville, VA (US)

Correspondence Address: PARKER INTELLECTUAL PROPERTY LAW OFFICE, 536 PANTOPS CENTER, # 234, CHARLOTTESVILLE, VA, 22911, US

(21) Appl. No.: 11/796,194

(22) Filed: Apr. 27, 2007

(51) Int. Cl. G06K 7/00

(52) U.S. Cl. 235/435

(57) ABSTRACT

A system, apparatus and method for providing human readable recognition of an item labeled with a machine readable identification code, such as RFID or barcodes. The terminal units have an outer casing, a microprocessor, and a machine readable identification code reader to read code placed exterior to the outer casing for display on a screen. The terminal unit can have an alignment fixture to indicate the placement of the machine readable identification code and does not require a user to contact the unit. Remote computers can be used to house the administrative software and communicate with the terminal through communication means. The administrative software consists of an administrative database, bridge software and monitor software. In other embodiments the administrative software is housed in the individual terminal units. An identification database stores the machine readable identification code and data associated with the code, communicating with the monitor and bridge software. The identification database can be stored within the terminal, in the remote computers or in remote servers.

### BACKGROUND

1. Field of the Invention

The present invention relates generally to a software and apparatus for reading bar codes, and specifically for an apparatus and software that reads machine readable identifiers and displays the contents in user readable format.

2. Related Art

As high-throughput screening and genomics laboratories have increased the number of biological samples, they have adopted numerous technological improvements. For example, robotic liquid pipetting stations perform the work previously done by humans using handheld pipetters. An important innovation in the laboratory has been the adoption of barcoding to identify samples. Previously, samples were stored in test tubes and were labeled with human readable (textual) descriptions of the contents. The information recorded on these labels varied according to the research goals of the lab, but typically included information such as sample ID, organism type, concentration, and/or collection date. With improvements in assay techniques, smaller sample volumes have been necessitated. Smaller sample volumes require smaller containers, which laboratories have embraced enthusiastically, due to the more efficient use of valuable storage space. However, the disadvantage of using smaller containers has been that there is no longer room on a very small vial to record human-readable descriptions of the contents. Thus, barcodes are often used to record this information. The barcode contains a unique identifier (ID) which is used as a primary key in a computer database. This key, when read from the vial's barcode, can be used to query the computer database and retrieve information concerning the vial. In some cases, the barcode encodes the laboratory's assigned ID for the sample, and the lab applies these barcodes. Techniques for applying barcodes include adhesive, inkjet, and laser etching.

In other cases, the manufacturer of the vial permanently etches a random, unique ID number on every vial. This type of vial is sold by a variety of vendors including Matrix, Micronics, and AbGene. The laboratory must then read this ID from the vial when the sample material is placed in the vial, and store this ID in a database along with the other information pertinent to the sample.

In either case, a sample vial labeled solely with a barcode does not present the user with any useful means to identify the contents inside.

Those labs that print and apply their own barcode labels often print human readable information on the same label. Typically, the vial ID is printed numerically as well as encoded in the barcode. However, the vial ID is only a string of alphanumeric characters, and does not describe the contents of the vial. As vials become smaller, it is impossible to fit a barcode label on the vial. This is often the case with pre-labeled vials. These vials (approximately 5 mm in diameter and 45 mm in length) are so small that the application of a label is impossible, and would pose great problems for any automated equipment handling the vial.

These problems have limited acceptance of smaller vials that have no means for human-readable labeling. Many laboratory personnel do not trust the systems in place for tracking the contents of vials, and are concerned that they are not handling the correct vial. They would like a realtime, simple, inexpensive way to verify the contents of a vial at the site where the vial will be handled.

The disclosed invention meets the lab personnel's requirements by providing a solution that is easy to use, easy to deploy, and is simple and inexpensive.

### SUMMARY

A system, apparatus and method for providing human readable recognition of an item labeled with a machine readable identification code is disclosed. The system has at least one standalone terminal unit, each of which has an outer casing, a microprocessor, and a machine readable identification code reader in communication with the microprocessor. The reader can read the machine readable identification code placed external to the outer casing. A display screen receives the data from the microprocessor where it is displayed in user readable characters. The terminal also has terminal communications and a power supplies. The terminal unit can, in some embodiments, have an alignment fixture that indicates the placement of the machine readable identification code. In other embodiments the terminal can be handheld. In the terminals that are standalone the user does not need to contact the unit.

One or more remote computers can be used to house the administrative software and communicate with the terminal through communication means. The administrative software consists of an administrative database, bridge software and monitor software. In other embodiments the administrative software is housed in the individual terminal units.

The administrative database contains information pertaining to each of the terminal units and processes requests from each terminal based upon a set of criteria established by tables within said administrative database. The tables contain for each terminal unit tables providing textual names and properties for each terminal unit; a list of defined queries; connection information; a list of data fields returned for display; query identifiers; group queries; scanned machine readable identification code not contained in said identification database.

The bridge software communicates with the administrative database and provides a user interface, enabling a user to modify, view, and format data in the administrative database. The bridge software provides a graphical view of each terminal unit; a graphical view of each terminal unit's status, indicating if the terminal is new, connected or disconnected; editing ability for each terminal unit; forming, editing and displaying groups and group properties; editing and displaying queries and query properties; discerning the schema of an identification database and providing a graphical display of the schema; editing and displaying server definitions and creating new records.

The monitor software communicates with each of the terminal units and the administrative database to execute applications between each of the terminal units, the monitor software and the administrative database. Although in one embodiment the monitor software can continuously execute the applications between the terminal units, in other embodiments the execution can be interrupted. The monitor software performs identification of each of the terminal unit sending lookup requests; processing of lookup requests from each terminal unit and returning formatted data for display with a concatenated prefix and suffix; checking for and identifying the group membership of each terminal unit sending lookup requests; logging of unrecognized identifiers; logging of activity timestamps; logging of commands issued; processing of new terminal unit connections; maintaining a simple graphical status window indicating the program is operating; indicating the network interface that the monitoring application is monitoring for requests; providing support for software plug-ins that perform secondary processing.

An identification database stores the machine readable identification code and data associated with the code and communicates with the monitor and bridge software. When multiple sources of data are accessed, such as multiple remote servers, the data within each of the identification database does not need to be the same type of database and can contain information unique to the specific database. The identification database can be stored within the terminal, in the remote computers or in remote servers.

The machine readable identification code reader can be bar codes, RFID or any other currently known code, or future code. The communications between the terminal and remote computer and remote computer and server can be wireless or hardwired, depending upon the location.

To scan an item labeled with a machine readable identification code, the item is placed exterior to the outer casing of the terminal unit over a code reader. The machine readable identification code is read and transmitted as a request for data associated with the machine readable identification code to a remote computer. The request is received by the monitor software that looks up query and formatting information associated with the terminal in the administrative database. The request is converted into a query and the query communicated to an identification database. When the response to the query is received from the identification database, the display information is formatted and transmitted to the terminal as human readable format.

In some embodiments the terminal is a standalone unit. The terminals have an outer casing, a microprocessor, a machine readable identification code reader, to read machine readable identification code placed exterior to the outer casing, a display screen for displaying said user readable characters, communication means, and a power supply. A storage unit can include an administrative database to provide a user interface, bridge software for communicating with the administrative database, monitor software for communicating with the bridge software, and a database for storing the machine readable code. The database is in communication with both the monitor and bridge software.

### BRIEF DESCRIPTION OF THE DRAWINGS

The preferred embodiments of the present invention are shown by a way of example, and not limitation, in the accompanying figures, in which:

FIG. 1 is a perspective view of an example terminal in accordance with the disclosed invention;

FIG. 2 is a dataflow diagram of the overall system in accordance with the disclosed invention,

FIG. 3 is a diagram of the architecture of a terminal in accordance with the disclosed invention;

FIG. 4A is a flow chart of the operating logic for a terminal in accordance with the disclosed invention;

FIG. 4B is a flow chart of the interrupt service routine for a terminal in accordance with the disclosed invention;

FIG. 5A is a flow chart of the start up routine for the monitoring software in accordance with the disclosed invention;

FIG. 5B is a flow chart of the polling operating for the monitoring application in accordance with the disclosed invention;

FIG. 5C is a flow chart of the answer request subroutine for the monitoring application in accordance with the disclosed invention;

FIG. 6 is a dataflow diagram of the system without monitoring plug-in software in accordance with the disclosed invention;

FIG. 7 is a dataflow diagram of the monitoring plug-in software in accordance with the disclosed invention;

FIG. 8 is a dataflow diagram of the administration application in accordance with the disclosed invention;

FIG. 9 is a cutaway view of the interior of the example terminal of FIG. 1 in accordance with the disclosed invention;

FIG. 10 illustrates the graphical user interface of the administration application showing the example terminals in accordance with the disclosed invention;

FIG. 11 illustrates the graphical user interface of the administration application showing the terminal set up screen in accordance with the disclosed invention;

FIG. 12 illustrates the graphical user interface of the administration application showing the query input screen in accordance with the disclosed invention; and

FIG. 13 illustrates the graphical user interface of the administration application showing the displayed data selection screen in accordance with the disclosed invention.

### DETAILED DESCRIPTION OF THE INVENTION

Definitions:

For the purposes herein the term “administrative software” will refer to any software that controls and instructs a computer, or other electronics having a microprocessor, to perform a task.

For the purposes herein the term “bar code” will refer to a machine-readable representation of information in a visual format on a surface. Barcodes store data in the widths and spacings of printed parallel lines, and in patterns of dots and concentric circles. Barcodes can be read by optical scanners called barcode readers or scanned from an image by special software.

For the purposes herein the term “bridge software” will refer to any software that that is used to specify how database requests can be made based on requests from remote devices. It specifies information associated with a device having a microprocessor, including, but not limited to, assigning the devices to groups, monitoring the status of the devices, specifying queries, and specifying the location and type of identification databases that the system will access. The software can be graphical or non-graphical and can used interactively on an as-needed or consistently needed basis

For the purposes herein the term “database” will refer to any structured collection of records or data stored in a computer in a manner to enable a program to access the stored records or data to answer queries.

For the purposes herein the term “monitor” will refer to any software that executes continuously, or with short interruptions, acting as a conduit for information to and from remote and/or internal applications, devices and databases.

For the purposes herein the term “query” or “queries” will refer to any request for any records or data from a database or to a predetermined specification for such a request.

For the purposes herein the term “machine readable identification codes” shall include any identifier imprinted or attached to an article that can be read by a scanning device using optical or radio frequency means, including but not limited to printed bar codes, etched bar codes, and/or RFID.

For the purposes herein the term “RFID” will refer to Radio Frequency Identification and a “RFID tag” is an object that can be attached to or incorporated into a product, animal, or person for the purpose of identification using radio waves. Typical chip-based RFID tags contain silicon chips and antennae. Passive tags require no internal power source, whereas active tags require a power source.

For the purposes herein the term “terminal” will refer to any hardware unit of any design that can scan, interpret and display data received from a machine readable identification code.

The disclosed system and apparatus provides a simple method to enable users of containers, or other items, marked with machine-readable identification codes (either barcodes or RFID tags) to ascertain information pertaining to that container or item. The system reads the code, looks up the information corresponding to the specific code and displays it to the user, via a screen on the terminal. Although the disclosed system can be used to read identification codes on any item, for ease of description herein reference will be made to specimen vials. However, anyone skilled in the art will readily ascertain how this disclosed system can be advantageous in other fields. Examples of these would be computer, or other small mass produced, parts, archeological artifacts, medicines, animal tracking, etc.

When used in specimen vial tracking, this information can typically include a description of the contents or intended contents of the vial, a lot number, a patient ID, a study number, etc. Some of the benefits are that errors are reduced, user acceptance of machine-readable marking schemes is improved, and processing throughput is improved due to the reduction in labor.

In one embodiment the system is composed of one or more barcode reading terminals communicating with one personal computer (PC). The PC is responsible for accepting barcode ID codes from the terminals, via wired or wireless communication, matching those bar codes with a customizable database on a centralized server and returning a corresponding data record for display to the user. Software communicating with the terminal enables the configuration of the precise data fields that should be displayed on each terminal; enabling each terminal to display the information required for the individual location or lab. The PC can either contain an identification database for this purpose, or query one or more external servers containing an identification database, depending upon the needs of the individual facility. The barcode reading terminals can be designed to be small and unobtrusive, allowing them to be deployed at every point in a facility where the containers are used or filled.

In another embodiment the terminal can be a standalone system that receives downloaded data, in mass, rather than remaining in constant communication with a PC and/or server. The downloading can be accomplished by periodic scanning or communication with a master source. This embodiment is directed to uses where the items being scanned are not added to or changed frequently. An example of this would be scanning small parts, such as computer related items, where only a finite number of different parts are ever scanned.

In still another embodiment, the PC can contain the database, forming an in-house, isolated system. This would be applicable to small labs or manufacturing facilities which all items are isolated within the one facility and information is not shared with other facilities.

It should be noted that the remote servers can be third party or in-house and can use any communication between the PC, terminals and servers currently known to those skilled in the computer arts.

The size and design are dependent upon the end use and physical alterations will be evident to those skilled in the art. In some embodiments, the terminals are designed to be used without the user having to pick up the scanner or press any buttons. In other embodiments, the reader can be a handheld scanner or a subcomponent of a larger system such as a robotic assembly line.

### System Description

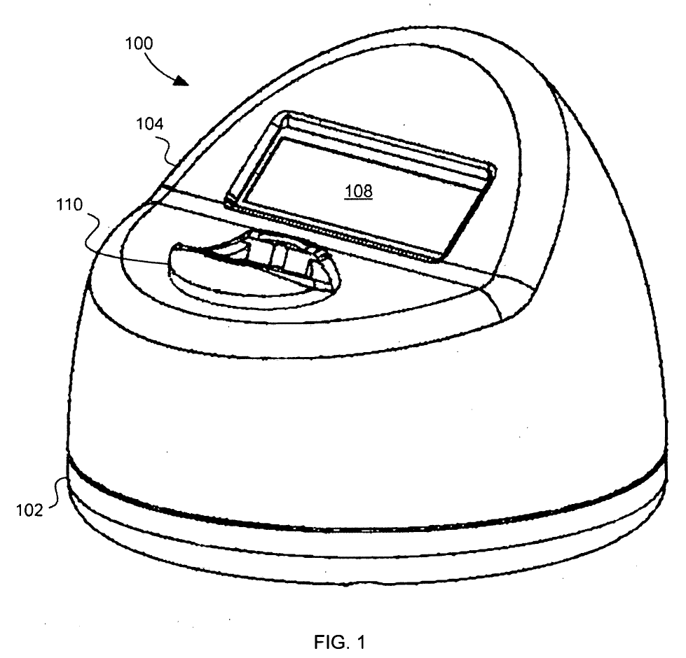

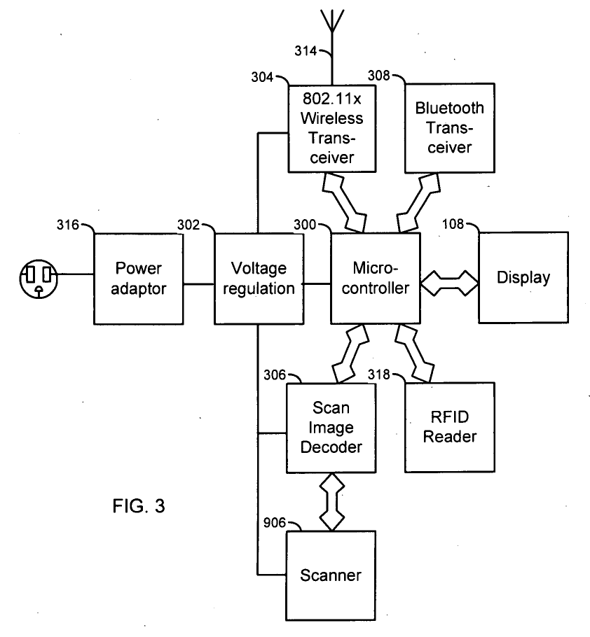

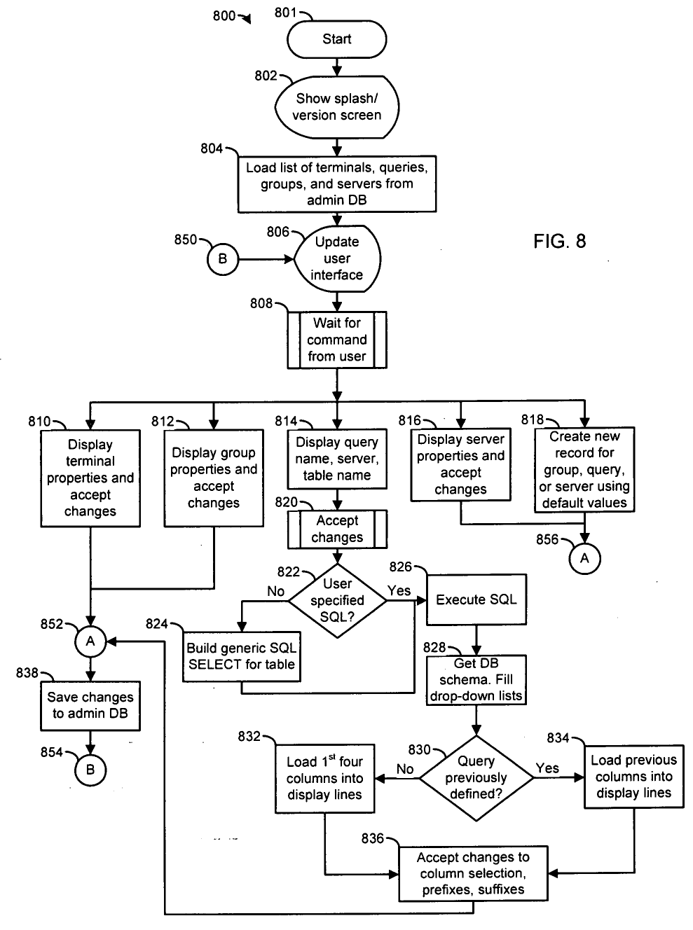

The disclosed system includes one or more terminals 100, an example of which is illustrated in FIGS. 1 and 9, that consist of a base 102, a cover 104, a back panel 106, a display (including cable) 108, a display bracket 902, a printed circuit board 904, a barcode scanner 906, a barcode scanner bracket 908, a scanner cable 910, a vertical mirror 913 and an angled mirror 912, a window 914, an antenna 314 (FIG. 3), an alignment fixture 110 and a power adaptor 316. The terminal 100 can be provided with either a visual or audible indicator that the terminal 100 is ready for use. The display 108 is mounted on a bracket 902 that also holds the vertical mirror 913. Although in most applications direct power is preferable, in some applications using a battery as the power source could be preferable. These applications can include those where no power outlets are readily available, the terminal 100 is moved frequently, power cords present a hazard, etc. Alternatively, the terminal 100 can have the option for both power sources and contain rechargeable batteries. The adaptation of a terminal 100 from the illustrated wired power to battery power or a combination thereof will be evident to those skilled in the art. The display 108, bracket 902 and vertical mirror 913 are attached to the cover 104, enabling the display 108 to be seen from outside the cover 104. The barcode scanner 906 and the angled mirror 912 are attached to the barcode scanner bracket 908, which is attached to the base 102, along with the printed circuit board 904 and back panel 106. The scanner cable 910 connects the scanner 906 to the printed circuit board 904. The display cable (not shown) connects the display 108 to the printed circuit board 904. The cover 104 is attached to the base 102. The window 914 and alignment fixture 110 are placed into the recessed opening on the cover 104. The positioning of the alignment fixture 110 should be such that the item to be scanned can be quickly presented and scanned. This is unique over many prior art scanning devices where the item has to be placed within the terminal. The antenna 314 and power adapter 316 (FIG. 3) are attached to the completed unit by the user, at the time of installation.

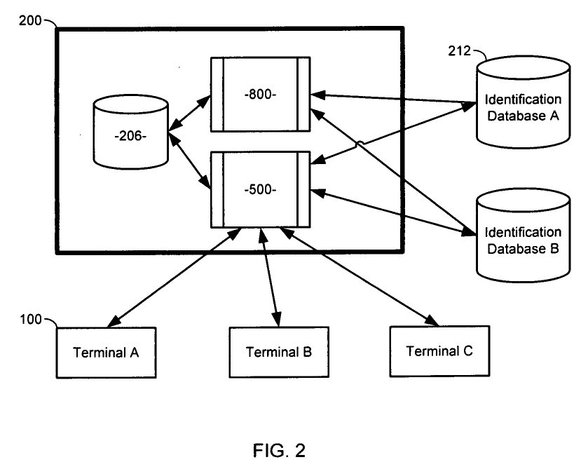

The terminals 100 communicate with a remotely located personal computer (PC) 200 as illustrated in the system architecture of FIG. 2. The physical location of the PC 200 in relation to the terminals 100 must support a communications link conforming to IEEE specification 802.11b/g, commonly referred to as WiFi, or an equivalent now known or that becomes know at a future date. The particular method of wireless communication could be implemented in other means, such as Bluetooth or other means. For IEEE 802.11b/g communication, the effective range is 50-300 feet, with consideration given to the number of intervening walls, appliances, etc. Alternatively, the terminal 100 wireless transceiver 304 can be configured to communicate with the PC 200 via Ethernet cable, or there may be a combination of wireless and “wired” terminals 100 communicating with the PC 200. In either case, one PC 200 can serve as a bridge between one or more terminals 100 and one or more identification database(s) 212. The identification database(s) 212, in embodiments where they are being used, can be located on computers remotely located from the PC 200 in the same or different physical locations. This provides a data communications pathway between the identification database(s) 212 and the terminals 210.

The PC 200 also supports the administrative database 206, described below. There are two software applications running on the PC 200. The monitor software 204 has the communicates with the administrative database 206 to access query formatting information, to record heartbeat timestamp records for each terminal, and to record unknown identifiers. The bridge software 500 communicates with the administrative database 206 to access and update query formatting information, as well as the other tables in the database 206. The monitor software issues queries to one or more identification databases 212 to process lookup requests from the terminals 100. The bridge software 202 also queries the identification databases 212, but only to obtain schema information describing the identification databases 212. This schema information is displayed graphically by the bridge software, enabling the user to define queries and formatting rules. The software running on the PC 200 makes use of a shared administration database. This database is primarily read by the monitoring software 500 (to enable it to service lookup requests) and is primarily updated by the bridge software 800 which has graphical screens to simplify administration of the database.

An example of a logical relationship of the components of terminal 100 is illustrated in FIG. 3, however other architectures will be evident to those skilled in the art depending the end use and physical design of the terminal. The printed circuit board 904 includes the functional sections. The microcontroller (including read-only memory and random access memory) 300 is directly connected to the voltage regulation 302 as is the wireless transceiver 304 and scan image decoder 306. The scanner 906 feeds data directly to the scan image decoder 306. The voltage regulation 302 is also connected to the power adaptor 316. The wireless transceiver 304 is in two way communication with the antenna 314. The microcontroller is in two way communication with the wireless transceiver 304, scan image decoder 306, display 108 and (optional) Bluetooth transceiver module 308. This same connectivity would be applicable if an RFID reader 316 was either substituted or included in the implementation. Various electrical buses and physical interconnects tie these functional sections together.

An example of a barcode scanner having the capabilities required in the present implementation is a Symbol Technologies SE4400 scanner. The scan image decoder is a Symbol Technologies PL4407. Together, these devices support the decoding of virtually all standard barcode symbologies. However, any barcode scanner module can be used that can be mounted in the body and meets the criteria as set forth herein.

If the Bluetooth module is installed, the system monitors both the internal scanner 906 and the Bluetooth module 308 for barcode information. If a barcode scan is successfully performed by either the internal scanner 906 or the Bluetooth module 308, the information is treated identically, as described hereinafter. The Bluetooth module 308 can be internal, replacing or in additional to, the scanner 906 and/or a Bluetooth-enabled handheld barcode scanner (not shown). Additionally, any Bluetooth-enabled serial port protocol (SPP) device may be used to transmit barcodes to the Terminal 100 (i.e. a Bluetooth-enabled keyboard could be used to allow manually entered alphanumeric identifiers to be looked up).

As stated heretofore, the written display can be any number of lines appropriate to the dimensioning of the display 108, however as used for example herein a four (4) line by 20 character LCD character display is described. This configuration enables four discrete items of information to be displayed concerning the scanned barcode. The monitor software described hereinafter can combine information to display multiple data on each line. Any type of display (character or graphical) could be used.

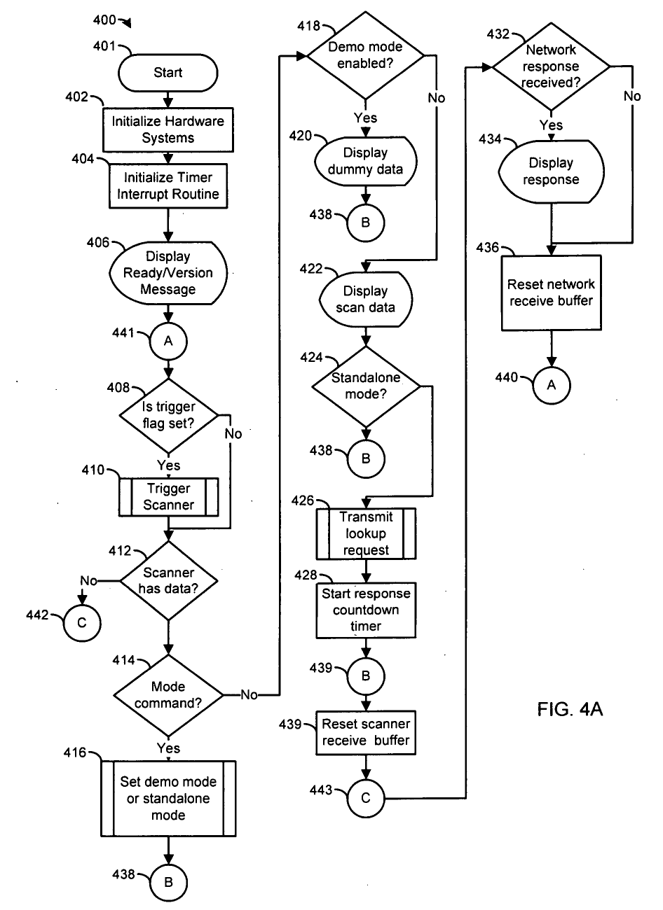

The terminals 100 are initialized by embedded control software 400 examples of which are illustrated in FIGS. 4A and 4B. In this implementation, the embedded control software 400 is implemented in PIC assembly language, and is hosted by a Microchip Corporation PIC16F877A microcontroller; however, other languages and/or microcontrollers could be used.

FIG. 4A illustrates the logic of the embedded control software 400 in terminal 100. Upon start 401, the hardware systems are initialized 402, as well as the initialization of the interrupt service routine 440, the flow of which is illustrated in the Timer Interrupt Routine 448 of FIG. 4B. A version number message is displayed 406. The trigger flag internal to the microcontroller 300 is then examined 408 to determine if it is set. If so, the scanner is triggered 410. If not, the scanner is not triggered. In either case, the scanner is checked 412 for receipt of scan data. If no scan data is found, the system proceeds to exit point C 442. If scan data is present, the scan data is examined 414 for a mode command, which is a pre-programmed particular sequence of characters unlikely to be found in a typical machine-readable identification code. If a mode command is recognized, the mode is set to demo or standalone 416 based on a pre-programmed sequence of characters. The programming of the sequence to differentiate between the modes is known to those skilled in the art. If a mode command is not found, execution proceeds to exit point B 438.

If no mode command was found upon examination 414, the state of the mode flag is examined to determine if demo mode has been set 418. If so, dummy data is displayed 420 and execution proceeds to exit point B 438. If demo mode has not been set, the scan data is displayed 422. The standalone flag is examined 424 to determine if it is set. If so, execution proceeds to exit point B 438. If not, the data is transmitted as a lookup request 426 and the response countdown timer is started 428 as described hereinafter.

The program execution that has entered exit point B 438 enters and resumes at entry point B 439. After entry, the scanner receive buffer is reset 430 and the program execution entering exit point C 442 now enters and resumes at entry point C 443.

Determination of the presence of network data reception 432 is made. If network response 432 is not detected, the program execution proceeds to exit point A 440. All execution entering exit point A 440 resumes at entry point A 441 to repeat the processing indefinitely until network response 432 is detected.

If it is determined that network response 432 is present, the network response is displayed 434, the network receive buffer is reset 436, and program enters exit point A 440.

The interrupt service routine 448 is invoked by data reception from scanner 206 or network transceiver 304 or by a 14 Hz timer internal to the microcontroller 300.

Upon invocation, subsecond counter internal to microcontroller 300 is decremented 452 from a preprogrammed maximum waiting period. If the counter equals zero then the seconds counter is incremented. The heartbeat counter internal to microcontroller 300 is decremented 454. If the heartbeat counter equals zero 456 then a heartbeat message is transmitted 458 and the heartbeat counter is reset to a preprogrammed heartbeat interval. In either case, the trigger countdown internal to the microcontroller 300 is examined to determine if it is non-zero. If so, the trigger countdown is decremented 470 and compared to zero. If zero then the error flag internal to the microcontroller 300 is set. If execution step 460 revealed that trigger countdown was not equal to zero, then if network data is available 462, the trigger flag is set. Regardless of the results of steps 460 and 462, execution proceeds to storage 466 of data in the scanner receive buffer and storage 468 of data in the network receive buffer. The interrupt service routine then terminates 476.

### Monitor Software

The monitoring software 500 runs continuously, or with nanosecond interruptions, awaiting identifier lookup requests from terminals 100.

Primary functions performed by the monitoring software are:

Processing of lookup requests from Terminals 100 and returning formatted data for display,

Logging of unrecognized identifiers

Logging of activity timestamps

Logging of SQL commands issued

Processing of new terminal 100 connections

Maintaining a simple graphical status window that indicates the program is operating, and indicates the network interface that the monitoring application is monitoring for requests.

Providing support for software plug-ins that perform secondary processing

Each of these functions is described hereinafter.

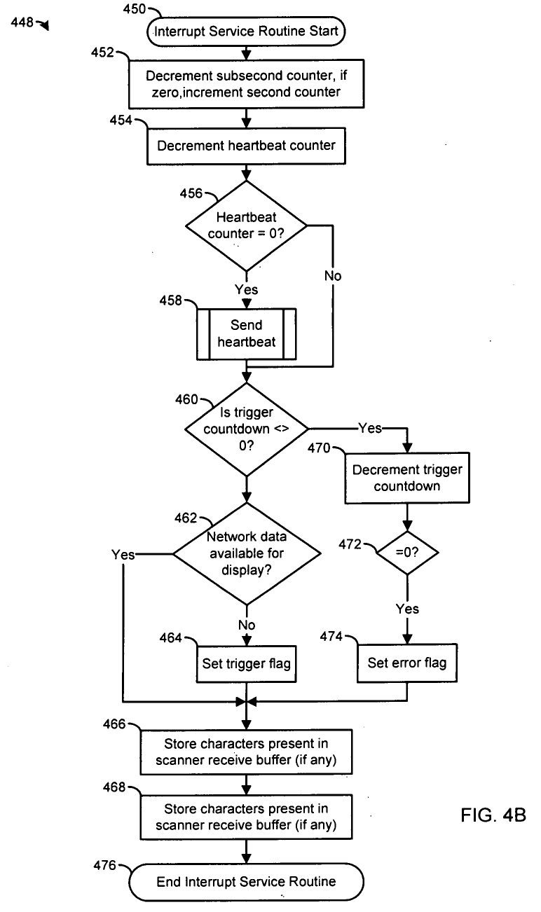

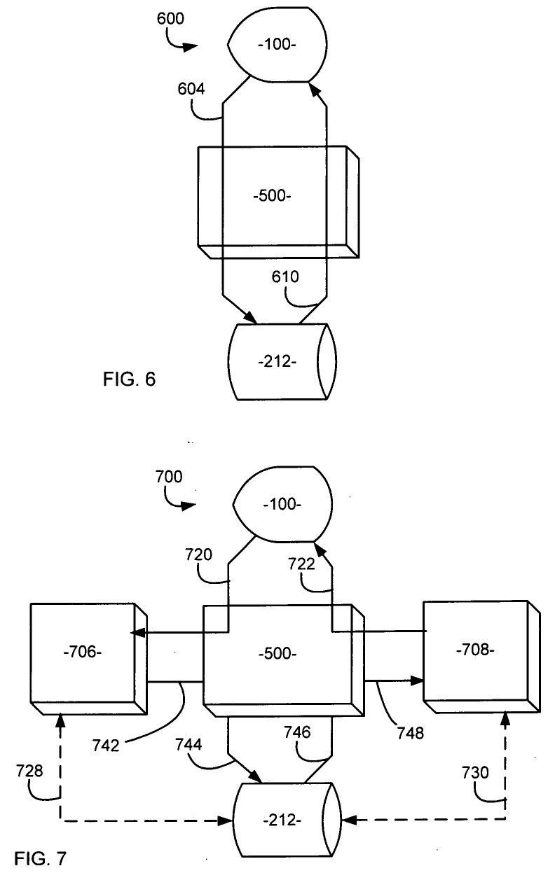

The monitoring software is comprised of an initialization routine as illustrated in FIG. 5A, a polling thread as illustrated in FIG. 5B and a timer service routine as illustrated in FIG. 5C. These components are coordinated via functionality built into a multitasking operating system such as Windows XP. The monitor software maintains data referred to herein as a terminal object in memory for each terminal 100 that has recently communicated with the monitoring software. This improves performance of the software and improves the speed of the data request process. The terminal object contains the terminal's network address, a base query used to retrieve data from the database, and query formatting information for formatting the database responses for display on the terminal 100. If a terminal object for a particular terminal 100 was previously loaded, but has communicated recently with the monitoring software, the terminal object is purged to conserve memory As illustrated in FIG. 5A, the monitoring software 500A begins by determining which network interface in the PC 800 (FIG. 8) should be monitored 502. This determination is made as follows. If there is only one network interface present, that interface is used. If there is more than one interface, a configuration file in a preprogrammed location specifies the correct network interface to monitor based on the IP address. The configuration file is also examined to establish the default groups and queries 504. A monitoring object, which is described in FIG. 5B, is created 506 and an interval timer with a preprogrammed period is started 508. The interval timer is built into the multitasking operating system. At this point, the initialization routine 500A ends.

The monitoring object 500B begins by starting a polling thread 520. The network interface is examined for the receipt of a data request from a terminal 100. This step is performed until a data request is present. When a data request is present, the terminal 100 that issued the data request is identified via examining 524 the data request's source address. If there is not a data object already loaded 526 that corresponds to the source terminal 100, a terminal data object is loaded 528 and added to the queue 530.

If the monitor software cannot find a record in the administration database 206 corresponding to this terminal 100, when loading 528, it checks to see whether the terminal 100 is new 532. If the terminal 100 is in the database 260, the properties are loaded from the database 532 and the system returns to instantiate the terminal object 528. If the terminal is new, a temporary entry is created based upon the IP address and placed in the admin database 536 for this terminal 100 and the system then returns to instantiate the terminal object 528. The recorded information consists of the IP address of the terminal 100 and a descriptive name and a default query. The descriptive name is “IP:” followed by the IP address of the terminal 100. This enables the bridge software to display a special symbol to indicate that this is a new terminal 100. This descriptive name also causes the monitoring software to return a message to the terminal 100 that indicates to the user that the terminal 100 needs to be configured on the PC. Together, these features enable for automatic recognition and configuration of new terminals 100, which contribute to the system's ease of use. This temporary information may be later changed and confirmed by the user using the bridge software 800.

In either case, the terminal object is added to a queue 530 that is examined in the timer service routine 500C. Note that the monitoring application 500 can process requests arriving from multiple terminals 100. This is made possible by a First-in-First-out message queue. Also, each database request is issued in a separate thread of execution, so that a delayed response from one database will not adversely impact other queries that may be in progress.

The interval timer causes a software interrupt to occur, which causes the initiation 510 of the timer service routine 500C of FIG. 5C. Once initiated, the presence of waiting requests in the queue 512 is checked. If there are requests 514, the system starts the answer request subroutine 540 and passes the request to the inbound plug-in 542. Whether the system has received a heartbeat or a data request is determined 544 is determined. If a heartbeat is received, the activity is recorded and time stamped in the administration database 566.

If it is determined that the data request is not a heartbeat 544, then the data request is examined for proper formation 546. If the data request is ill-formed the activity is recorded and time stamped in the administration database 566. If the data request is not ill-formed 546, the data request is converted into a query using a base query associated with the requesting terminal 100 and is executed against the database 548 associated with the requesting terminal 100. If the query succeeds 550, the data returned by the query is formatted for display 554 according to the query format associated with the requesting terminal 100. If the query does not succeed 550, this serves as an indication that the data requested was not found in the database. In this case, the unknown data requested is tagged as an unknown identifier 552.

In all cases, the activity is recorded and time stamped in the administration database 566. This enables the bridge software, described hereinafter, to graphically display the connection status.

The query formatted for display is passed to the outbound plug-in 558 and the formatted response is transmitted 560 to the terminal 100. The answer request subroutine ends and any inactive terminal class objects are unloaded 516. The timer service routine then ends 518.

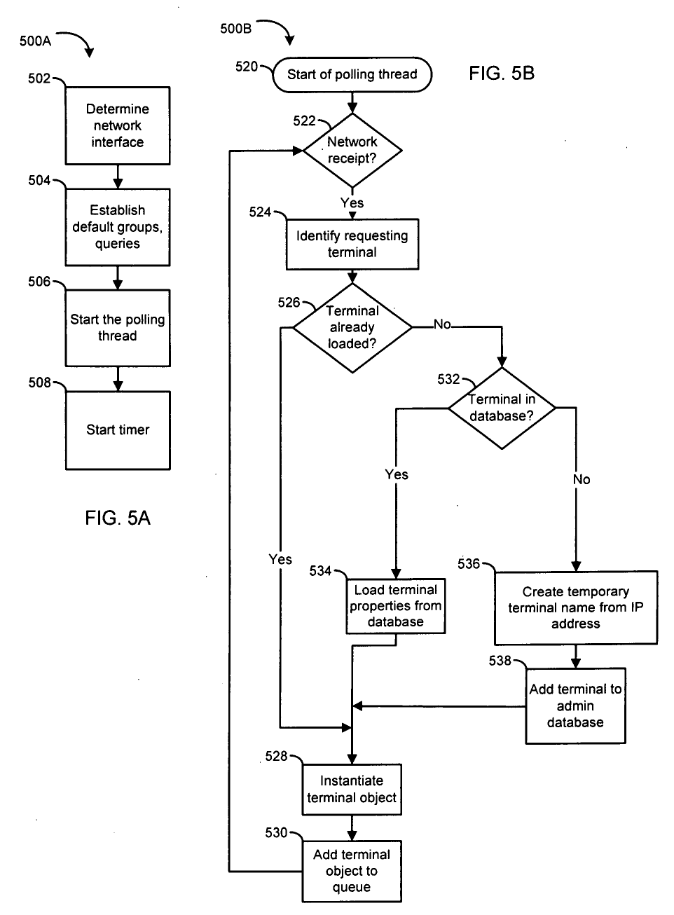

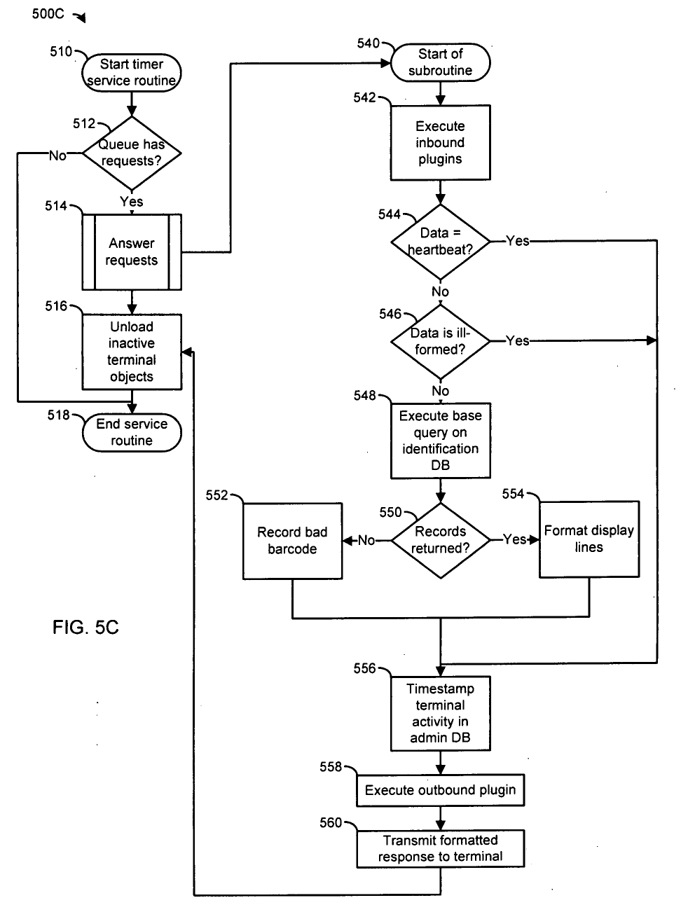

Referring to FIG. 6, the monitor software 500 receives a request 604 from the terminal 100. The request is converted into a query that is executed on the database 212. The results of the query 610 are then formatted by the monitor software 500 and are transmitted back to the terminal 100.

In the current implementation, the monitoring application 500 supports a ‘plug-in’ interface that enables a secondary software application to examine and possibly modify the information passing between the terminal 100 and the monitoring application 500. If there is a plug-in application 706 installed on the request side of the dataflow, this application is provided with read and possibly modify access to the information in the request 720. The plug-in application 706 may return a modified request 742 to the monitor software 500, which will then issue a corresponding database query 744 to the database 212.

If there is a plug-in application 708 installed on the response side of the dataflow, the results of the query 746 are formatted for display on terminal 100 by monitor software 500. The formatted results 748 are transmitted to the plug-in application 708 by the monitor software 500. The plug-in application 708 may read and possibly modify the database response and return the modified response 722 to the monitor software 500. The modified response 722 is then transmitted to the terminal 100 for display.

The plug-in applications 706 and 708 are optional, and may be used singly or together. The particular operations performed by these applications are left open to the developer of the plug-in. Typically, these operations will consist of textual modifications or additions. However, it is possible that the plug-in applications 706 and 708 may make auxiliary requests 728, 730 of the identification database 212 to either gather additional information or to update or insert new records into the database.

The implementation of plug-in applications 706 and 708 can enable communication to be maintained between subsequent operations. This would enable the action of the plug-in application to be based on data received from a series of requests. This enables, for example, multiple-step scanning operations to be performed. A multiple-step scan may consist of one scan of an employee ID badge, followed by a scan of a container being removed from inventory. A database record could be created that logs the removal and tags it with the identity of the employee.

### Bridge Software

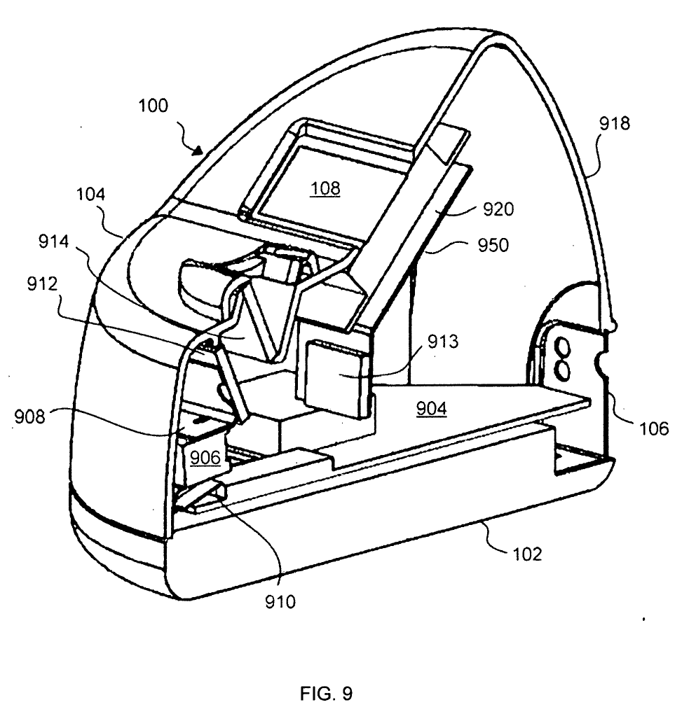

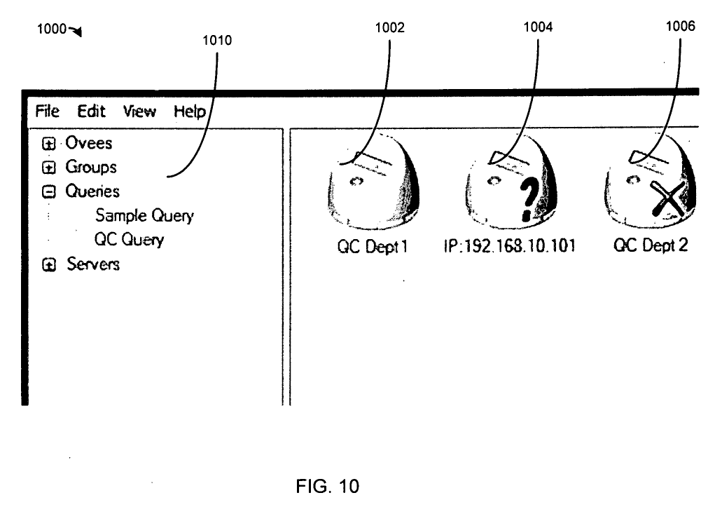

Bridge software 800 runs on the PC 200. The bridge software 800 provides a graphical view of the installed terminals 100 and their connection status, administrative tools used to configure the query and formatting rules assigned to each terminal 100. This is illustrated in FIG. 10 wherein the terminal 100 named QCDept 1 has been installed and it is communicating successfully with the bridge software 800. The execution flow of the bridge software 800 is illustrated in FIG. 8. Upon start 801 the version screen is display 802 and the list of terminals, groups, queries and servers is loaded from the administration database 804. The user interface is updated 806. The program waits for a command from the user 808. If the user chooses to edit the terminal 100, the terminal properties such as name, IP address, group membership, query assignment, physical location, and user, is displayed as shown in FIG. 11 enabling the user to make changes 810. Once the user makes the desired changes, execution proceeds to entry point 852.

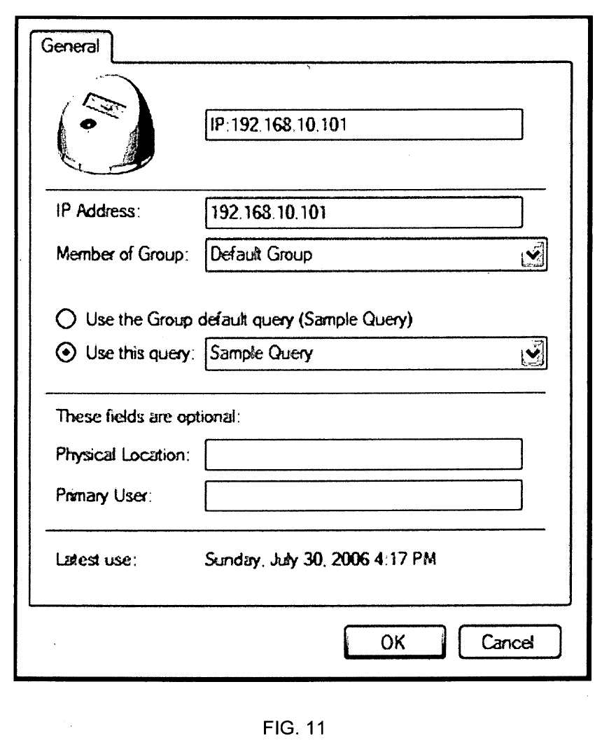

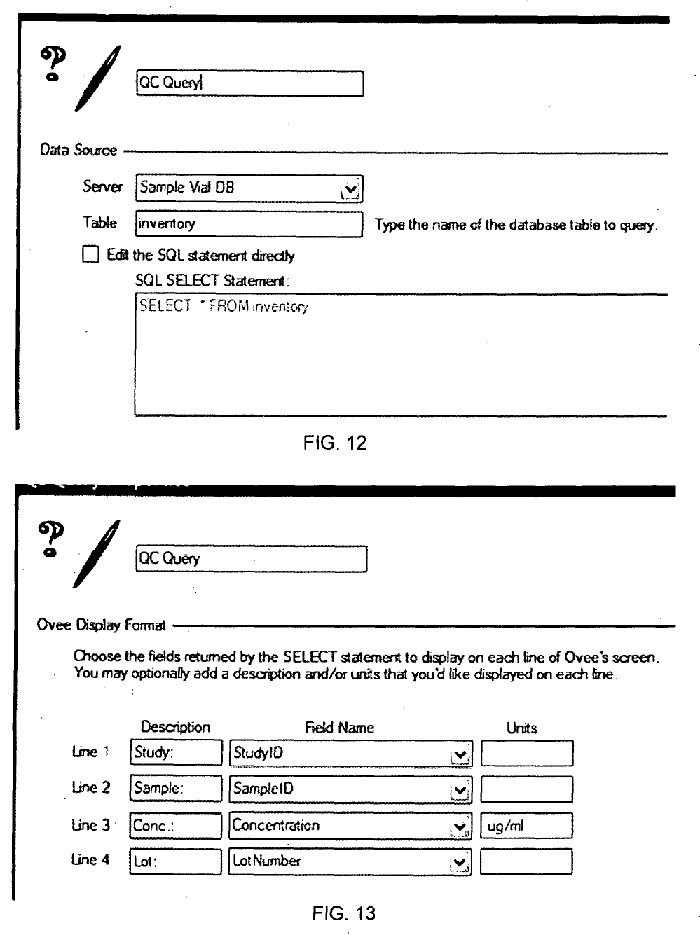

At point 808, the user may choose to edit the groups 812. The group properties are displayed and once changes are made 812, execution proceeds to entry point 852. At point 808 the user may choose to edit a query 814. The query is displayed as name, server, table name, and SQL statement as shown in FIG. 12. Once the user makes changes, the changes are accepted 820. If the user did not manually specify an SQL statement to use as a base query 822, a generic SQL SELECT statement is generated for the given table 824. Either the generic or the manually specified SQL 824 is executed 826. A list of columns is returned from the database 212. This list is used to populate 828 a set of drop-down lists as shown in FIG. 13. The admin database is examined to determine 830 if the query being edited is one that already has a set of default settings. If so, the previous columns are loaded into the display lines 834. If not, the first four columns returned by the SQL statement are loaded into the display lines 832. In either case, the user is given the opportunity to change the column selections, prefixes, and suffixes 836. Execution proceeds to entry point 852. If at 808, the user selects to edit a server, the server properties are displayed for changes 816. Once the changes have been completed, execution proceeds to exit point 856. If at 808, the user chooses to create new group, query, or server, and entry is created 818 using preprogrammed default values and execution proceeds to exit point 856.

All flows of execution entering exit point 856 resume execution at entry point 852. At entry point 852, all changes are saved 838 to the administration database 206. Execution proceeds to exit B 854 which resumes execution at entry point B 950. The software then updates the user interface 806 and the process repeats.

The administrative database 206 is organized as follows. A list of textual names for Terminals 100 is maintained (Table I), along with their Internet Protocol (IP) addresses. Each Terminal 100 has a named query associated with it. This triplet of information enables each incoming request to be recognized as to its source and also the query that should be run to service the request. A timestamp indicating the last time a terminal 100 issued a command (or a heartbeat) is also maintained.

Another table (Table IV) maintains a list of all Queries that have been defined. A Query is specifically a Structured Query Language (SQL) command and an identification of the server on which the SQL should be run. The SQL command will typically return one or more columns of data. In the typical implementation, these columns will only contain one row, because each identifier lookup will typically return only one entry from the database. The columns correspond to the various attributes and their values associated with this identifier record. The SQL command may also combine or derive information from multiple sources, such as tables or databases, or could access other file types, applications, and languages using standard database protocols.

Another administrative table (Table III) is used to establish which of the columns should be returned to the Terminal 100 for display. This table contains multiple records keyed to each query listed in Table IV. Each record contains the ID of the query, the column name, and the line number on the Terminal 100 screen on which the column data should be shown. There are two additional fields enabling a literal text string to be prefixed or suffixed to the column data.

As previously stated, each query is associated with an identification database 212. In this invention, an identification database 212 is described by a connection string, a database type, a database user ID, and a password. This information (Table II) allows the bridge software 800 and the monitor software 500 to connect to a local or remote identification database 212. As long as the identification database 212 is visible on the PC's 200 network, and the identification database 212 supports OLE DB or ODBC protocols (as almost all commercial database systems do), the bridge software 800 and monitor software 500 can connect using the connection string and query the identification database 212. This implementation also supports the use of native data providers, such as Microsoft SQL Data Provider, which are programming modules that allow direct efficient connection to an identification database 212 without the need to use OLE DB or ODBC protocols.

This database has the following schema:

TABLE I
A table containing one record for each known Terminal 100.
The fields are:

| | |
|---|---|
| NickName | Textual name of Terminal 100, for user recognition |
| Address | IP address of Terminal 100 |
| GroupID | Identifies the group membership of Terminal 100 |
| QueryID | Assigns a query specification to Terminal 100 |
| Location | Textual optional identifier of the Terminal 100's physical |
| | location, for user recognition |
| PrimaryUserID | Identifier of the principal user of the Terminal 100 |
| LatestPing | The time/date that the latest communications ping was |
| | received from this Terminal 100 |

TABLE II
A table containing connection information, called server definitions,
for identification databases 212 from which requests are made

| | |
|---|---|
| ServerID | Textual name of server definition, for user recognition and |
| | linkage within database |
| Connection | A database “connection string,” which is a concatenated list |
| | of keyword/value pairs that the identification database 212 |
| | requires clients to supply. |
| UserID | The identification database 212 user ID under which this |
| | server connection will be made. |
| QueryID | A default query ID that will be used on this server |
| | definition |
| DBType | A specifier for the type of identification database 212 being |
| | described. Examples include SQL, Microsoft Access, |
| | Oracle, etc. |
| Password | An encrypted copy of the password required by the |
| | identification database 212 for this User ID. This is |
| | specified as a separate field so it is not visible in the |
| | Connection string. |

Table III provides a list of database fields that should be returned from the identification database 212 to the Terminal 100. This list is grouped by QueryID, so that one query may cause multiple database fields to be returned. In the current implementation, each Query returns four database fields.

| | |
|---|---|
| QueryID | Keys this entry to a specific Query. |
| DisplayLine | Indicates the line on the Terminal 100 that the database |
| | field should be shown. |
| ColumnName | The name of the database field that should be returned. |
| Prefix | A literal text string that should be prefixed to each value |
| | generated by this entry. (For example, “Sample ID:”) |
| Suffix | A literal text string that should be suffixed to each value |
| | generated by this entry. (For example, “grams”) |

Table IV provides an identifier for each Query, defines a specific SQL command that should be used to query an identification database 212 for data, and indicates which identification database 212 should be queried.

| | |
|---|---|
| QueryID | A unique string identifier that provides a descriptive name |
| | that the user will see, and links this query record to entries |
| | in Table III |
| SQL | An SQL command. For example: “SELECT * FROM |
| | Inventory” |
| ServerID | Indicates the identification database 212 to query. This links |
| | this query record to an entry in Table II |

Table V provides a one-to-many mapping of QueryIDs to Groups. This enables one or more of Terminals 100 to be grouped and assigned a common QueryID. This logically groups Terminals 100 so that the configuration of the information that is to be served can be modified once at the bridge software 800, without any user intervention at the terminal 100, and all grouped terminals will subsequently be served using the modified configuration.
The Terminals 100 are assigned to a group in Table I.

| | |
|---|---|
| GroupID | The unique identifier of a group. |
| QueryID | An entry from Table IV. |

Another table contains a list of scanned identifiers that were not found in the database. This table contains columns that store the timestamp of the failed lookup, the terminal 100, the database 212, and the query.

A user table can be implemented to support role assignment and the granting of specific privileges to users, to track usage of the system, and to prevent unauthorized access to the bridge software.

FIG. 10 illustrates one of the graphical screens 1000 in the bridge software 800. In this figure, three terminal icons 1002, 1004, 1006 are displayed. Icon 1002 represents a terminal 100 that has been assigned a query and has communicated with the monitor software within a predetermined time period. Icon 1004 represents a terminal 100 that has an IP address for a name. Such a name would indicate that the monitor software 500 received a heartbeat or lookup request from this terminal 100, and there was not a corresponding record in Table I. Therefore, the monitoring application created a new record for this terminal 100 in Table I and used its IP address for its name. Icon 1006 represents a terminal 100 that has an assigned query, but has not communicated a request or a heartbeat to the monitor software 500 within a predetermined time period. Other exception conditions could be recognized by the software and indicated by symbols and icons in the bridge software display.

A graphical tree directory 1010 allows the user to access terminals 100, groups of terminals 100, queries, and server definitions.

What is claimed is:

1. A system for providing human readable recognition of an item labeled with a machine readable identification code, said system having:
at least one stand alone terminal unit, each of said at least one terminal unit comprising:
an outer casing,
a microprocessor,
a machine readable identification code reader, said reader being in communication with said microprocessor and reading said machine readable identification code placed external to said outer casing,
a display screen, said display screen receiving data from said microprocessor and displaying said user readable characters,
terminal communication means,
a power supply and
at least one remote computer, each of said at least one remote computer having:
administrative software, and
computer communication means, said computer communication means receiving and transmitting data to and from each of said at least one terminal unit through said terminal communication means.

2. The system of claim 1 wherein said administrative software comprises:
administrative database, said administrative database containing information pertaining to each of said at least one terminal unit,
bridge software, said bridge software communicating with said administrative database and providing a user interface,
monitor software, said monitor software communicating with each of said at least one terminal unit and said administrative database,

3. The system of claim 2 further comprising an identification database, said identification database storing said machine readable identification code and data associated with said machine readable identification code, and being in communication with said monitor software and said bridge software.

4. The system of claim 3 further comprising at least one remote server containing said identification database, each of said at least one remote server being in two way communication with said bridge software and said monitor software in each of said at least one remote computer.

5. The system of claim 4 wherein said identification database in each of said at least one remote server can contain data unique to said identification database.

6. The system of claim 2 wherein said bridge software enables a user to modify, view and format data in said administrative database.

7. The system of claim 2 wherein said bridge software performs at least one of the functions from a group comprising: providing a graphical view of said at least one terminal unit; providing a graphical view of each of said at least one terminal unit status; providing editing ability for each of said at least one terminal unit; forming, editing and displaying groups and group properties; editing and displaying queries and query properties; discerning the schema of an identification database and providing a graphical display of said schema; editing and displaying server definitions; creating new records.

8. The system of claim 7 wherein said at least one function is a plurality of functions.

9. The system of claim 7 wherein said status includes representation of new terminals.

10. The system of claim 7 wherein said status includes representation of each of said at least one terminal unit no longer in communication with said monitor software.

11. The system of claim 2 wherein said monitor software executes applications between each of said at least one terminal unit and said monitor software and said administrative database.

12. The system of claim 2 wherein said monitor software performs at least one of the functions from a group comprising: identifying each of said at least one terminal sending lookup requests; processing of lookup requests from each of said at least one terminal unit and returning formatted data for display; checking for and identifying the group membership of each said at least one terminal sending lookup requests; logging of unrecognized identifiers; logging of activity timestamps; logging of commands issued; processing of new terminal unit connections; maintaining a simple graphical status window indicating the program is operating; indicating the network interface that the monitoring application is monitoring for requests; providing support for software plug-ins that perform secondary processing.

13. The system of claim 12 wherein said at least one function is a plurality of functions.

14. The system of claim 12 wherein said monitor software concatenates a prefix and a suffix to said returning formatted data.

15. The system of claim 2 wherein said administrative database processes requests from each of said at least one terminal based upon a set of criteria established by tables within said administrative database.

16. The system of claim 2 wherein said administrative database contains for each of said at least one terminal unit at least one table from a group comprising: textual names and properties for each of said at least one terminal unit; a list of defined queries; connection information; a list of data fields returned for display; query identifiers; group queries; scanned machine readable identification code not contained in said identification database.

17. The system of claim 16 wherein said at least one table is a plurality of tables.

18. The system of claim 1 wherein said machine readable identification code reader is a RFID reader.

19. The system of claim 1 wherein said terminal communications means are wireless.

20. The system of claim 1 wherein said terminal communications means are hard wired.

21. The system of claim 1 wherein said at least one terminal unit further comprises an alignment fixture, said alignment fixture being on the exterior of each of said at least one terminal unit indicating placement of said machine readable identification code.

22. The system of claim 4 wherein said monitor software derives information from communicating with multiple sources.

23. The system of claim 1 wherein said at least one terminal unit is handheld.

24. The system of claim 1 wherein said computer communications means are wireless.

25. The system of claim 1 wherein said computer communications means are hard wired.

26. A system for providing human readable recognition of an item labeled with a machine readable identification code, said system having:
at least one stand alone terminal unit, each of said at least one terminal unit comprising:
an outer casing,
a microprocessor,
a machine readable identification code reader, said reader being in communication with said microprocessor and reading said machine readable identification code placed exterior to said outer casing,
a display screen, said display screen receiving data from said microprocessor and displaying said user readable characters,
terminal communication means,
a power supply and
at least one remote computer, each of said at least one remote computer having:
administrative software, said administration software comprising:
administrative database, said administrative database containing information pertaining to each of said at least one terminal unit and processing requests from each of said at least one terminal based upon a set of criteria established by tables within said administrative database,
bridge software, said bridge software communicating with said administrative database and providing a user interface to enable a user to modify, view and format data in said administrative database.
monitor software, said monitor software communicating with each of said at least one terminal unit and said administrative database to execute applications between each of said at least one terminal unit and said monitor software and said administrative database.
computer communication means, said computer communication means receiving and transmitting data to and from each of said at least one terminal unit through said terminal communication means.
at least one remote server containing an identification database, said identification database storing said machine readable identification code and data associated with said machine readable identification code,
each of said at least one remote server being in two way communication with said bridge software and said monitor software in each of said at least one remote computer

27. The system of claim 26 wherein said identification database in each of said at least one remote server can contain data unique to said identification database.

28. The system of claim 26 wherein said bridge software performs at least one of the functions from a group comprising: providing a graphical view of said at least one terminal unit; providing a graphical view of each of said at least one terminal unit status indicating new terminals, terminals connected and terminals no longer in communication with said monitor software; providing editing ability for each of said at least one terminal unit; forming, editing and displaying groups and group properties; editing and displaying queries and query properties; discerning the schema of an identification database and providing a graphical display of said schema; editing and displaying server definitions; creating new records.

29. The system of claim 28 wherein said at least one function is a plurality of functions.

30. The system of claim 26 wherein said monitor software performs at least one of the functions from a group comprising: identifying each of said at least one terminal sending lookup requests; processing of lookup requests from each of said at least one terminal unit and returning formatted data for display; concatenating a prefix and a suffix to said returning formatted data; checking for and identifying the group membership of each said at least one terminal sending lookup requests; logging of unrecognized identifiers; logging of activity timestamps; logging of commands issued; processing of new terminal unit connections; maintaining a simple graphical status window indicating the program is operating; indicating the network interface that the monitoring application is monitoring for requests; providing support for software plug-ins that perform secondary processing.

31. The system of claim 30 wherein said at least one function is a plurality of functions.

32. The system of claim 26 wherein said administrative database contains for each of said at least one terminal unit at least one table from a group comprising: textual names and properties for each of said at least one terminal unit; a list of defined queries; connection information; a list of data fields returned for display; query identifiers; group queries; scanned machine readable identification code not contained in said identification database.

33. The system of claim 32 wherein said at least one table is a plurality of tables.

34. The system of claim 26 wherein each of said at least one terminal further comprises an alignment fixture on said exterior casing, said alignment fixture indicating placement of said machine readable identification code.

35. The system of claim 26 wherein said monitor software derives information from communicating with multiple sources.

36. The system of claim 35 wherein said multiple sources contain data unique to each of said multiple source.

37. The system of claim 26 wherein said terminal is handheld.

38. A terminal for providing human readable recognition of an item labeled with a machine readable identification code, said terminal having:
an outer casing,
a microprocessor, said microprocessor containing software,
a machine readable identification code reader, said reader being in communication with said microprocessor and reading said machine readable identification code placed exterior to said outer casing,
a display screen, said display screen receiving data from said microprocessor and displaying said user readable characters,
communication means being in communication with said microprocessor,
a power supply
wherein said terminal reads machine readable identification code, translates said code to human readable format and displays said human readable format on said display screen.

39. A method for providing human readable recognition of an item labeled with a machine readable identification code using at least one stand alone terminal unit, comprising the steps of:
placing an item having a machine readable identification code exterior to a code reader at an outer casing of said terminal unit,
reading said machine readable identification code with a machine readable identification code reader,
transmitting a request for data associated with said machine readable identification code to a remote computer,
receiving said request by monitor software in said remote computer,
looking up query and formatting information associated with said terminal unit in administrative database,
converting said request into a query,
communicating said query to an identification database,
receiving query response from said identification database,
formatting display information from said query response,
transmitting said display information to said terminal unit;
displaying said display information in human readable format.

40. A system for providing human readable recognition of an item labeled with a machine readable identification code, said system having:
at least one stand alone terminal unit, each of said at least one terminal unit comprising:
an outer casing,
a microprocessor, said microprocessor containing software,
a machine readable identification code reader, said reader reading said machine readable identification code placed exterior to said outer casing,
a display screen, said display screen receiving data from said microprocessor and displaying said user readable characters,
communication means, and
a power supply,
a storage means, said storage means having an administrative database, said administration database providing a user interface, bridge software, said bridge software communicating with said administrative database, monitor software, said monitor software communicating with bridge software, and a database, said database storing said machine readable code and being in communication with said monitor software and said bridge software wherein said terminal unit does not require human contact.
